(19) United States
(12) Patent Application Publication
(10) Pub. No.: US 2024/0230145 A1
(43) Pub. Date: Jul. 11, 2024

(54) Additive Manufacturing of Fluid Ducts

(71) Applicant: Textron Aviation Inc., Wichita, KS (US)

(72) Inventor: Dhagash Shah, Wichita, KS (US)

(21) Appl. No.: 18/542,217

(22) Filed: Dec. 15, 2023

Related U.S. Application Data
(60) Provisional application No. 63/478,659, filed on Jan. 5, 2023.

(51) Int. Cl. F24F 13/02; B33Y 80/00

(52) U.S. Cl. CPC F24F 13/0245; B33Y 80/00; F24F 13/0209

(57) ABSTRACT

According to an embodiment, a duct for fluid transport includes a first duct segment and a second duct segment, each segment being formed using an additive manufacturing process. Each segment includes a body region and an edge region, with the second segment being configured to couple with the first segment along the edge region. The duct also includes at least one projection extending from the edge region of the first segment and at least one recess disposed along the edge region of the second segment, with the recess being substantially similar in shape to the projection. Additionally, at least one of the first duct segment and the second duct segment includes a lip extending along the length of the edge region.

### CROSS REFERENCE TO RELATED APPLICATIONS

This application claims priority to U.S. Provisional Patent No. 63/478,659, entitled Additive Manufacturing of Fluid Ducts, and filed on Jan. 5, 2023, the disclosure of which is incorporated herein, in its entirety, by reference.

### BACKGROUND

### 1. Field

The disclosure relates generally to the field of ducting. More specifically, the disclosure relates to additive manufacturing of fluid ducts and methods of joining thereof.

### 2. Related Art

Various solutions have been proposed for creating and joining air ducts using additive manufacturing processes and various welding techniques. For example, U.S. Pat. No. 10,126,062 to Cerny et al. discloses the formation of air duct segments using additive manufacturing processes from titanium-based materials and joining these segments using welds. U.S. Pat. No. 10,286,961 to Hillebrecht et al. discloses methods of joining components in lightweight vehicles such as aircraft, including using additive manufacturing processes to form titanium-based components, lap joints, and alignment tabs. U.S. patent Publication No. 2022/0099225 to Thompson et al. discloses forming titanium-based duct systems using additive manufacturing techniques, as well as welding adjacent components and using “slots” to aid alignment during manufacturing. U.S. patent Publication No. 2022/0260018 to Sidorovich Paradiso et al. discloses the formation of duct systems and the use of flanges to form lap joints, as well as the use of additive manufacturing techniques and titanium-based materials. U.S. patent Publication No. 2018/0334797 to Bucknell et al. discloses forming titanium-based components using additive manufacturing techniques and the use of notches to aid alignment.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, a duct for fluid transport includes a first duct segment and a second duct segment, each segment being formed using an additive manufacturing process. Each segment includes a body region and an edge region, with the second segment being configured to couple with the first segment along the edge region. The duct also includes at least one projection extending from the edge region of the first segment and at least one recess disposed along the edge region of the second segment, with the recess being substantially similar in shape to the projection. Additionally, at least one of the first duct segment and the second duct segment includes a lip extending along the length of the edge region.

According to another embodiment, a duct for fluid transport includes a body having an inlet at a first end and an outlet at a second end. The body includes at least one main body region and at least one secondary body region, with each body region having an edge portion extending along a perimeter thereof. The at least one main body region is formed from sheet metal, while the at least one secondary body region is formed an additive manufacturing process. The edge portion of the at least one main body region and the edge portion of the at least one secondary body region are rigidly coupled together to form the body.

### BRIEF DESCRIPTION OF THE DRAWING FIGURES

Illustrative embodiments of the present disclosure are described in detail below with reference to the attached drawing figures, wherein:

FIG. 1 illustrates an external side view of complimentary components of an embodiment of an air duct produced via additive manufacturing;

FIG. 2 illustrates a section view of the complimentary duct components of FIG. 1 along section 2-2;

FIG. 3 illustrates an external side view of the complimentary duct components of FIG. 1 which have been welded together;

FIG. 4 illustrates an internal side view of the complimentary duct components of FIG. 1 which have been welded together;

FIG. 5 illustrates a section view of an alternative embodiment of a fluid duct;

FIG. 6 illustrates an embodiment of a tab profile of a fluid duct segment;

FIG. 7 illustrates another embodiment of a tab profile of a fluid duct segment;

FIG. 8 illustrates an edge profile of an embodiment of a fluid duct segment;

FIG. 9 illustrates an edge profile of another embodiment of a fluid duct segment;

FIG. 10 illustrates an edge profile of yet another embodiment of a fluid duct segment;

FIG. 11 illustrates a front perspective view of an embodiment of a fluid duct formed using conventional and additive manufacturing processes; and

FIG. 12 illustrates an enlarged partial perspective view of a curved body region of the duct of FIG. 11.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

For consistency, the embodiments described herein relate primarily to air ducts or ducts intended for use with the transport and routing of gases. However, one of skill in the relevant art will appreciate that the following description and the embodiments shown may not be limited to air ducts, and may instead relate to ducts used for the routing and transportation of any known fluid. Likewise, one of skill in the relevant art will appreciate that the various ducting systems and/or methods of manufacture thereof may not be limited to aircraft and/or vehicular applications, and may therefore be relevant and useful in a variety of applications beyond those expressly described herein.

Existing duct systems, including those used in lightweight vehicles such as aircraft, are typically formed from sheet metal components. These sheet metal components may then be joined together using various methods known in the art, including welding such components together. Assembly of these ducts often requires additional tooling or alignment hardware in order to secure the duct components in place during the welding process. When these components are welded together, the pieces are typically adjacent to each other and form a “butt joint” weld at the connection. This weld can result in many undesirable qualities, including appearance and reduced strength compared to other welding joint types. The duct components disclosed herein may be formed from additive manufacturing techniques to create more desirable assembly traits, such as reduced hardware requirements, improved weld quality, and the capability to create ducts of increasingly complex shapes.

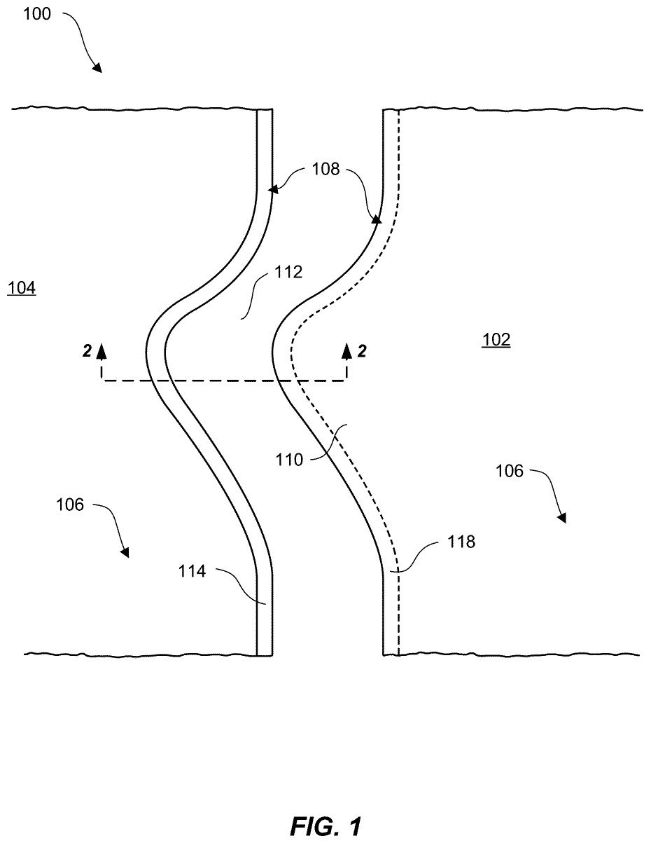

FIGS. 1-4 illustrate an embodiment of a duct 100 having at least two complimentary segments 102 and 104. Each complimentary segment includes a body region 106 and an edge region 108. In the illustrated embodiment, duct segment 102 includes at least one projection or tab 110 which extends from the edge region 108, while the duct segment 104 includes a recess 112 which is complimentary in shape and size to the tab 110, such that duct segments 102 and 104 may fit together along the length of edge regions 108.

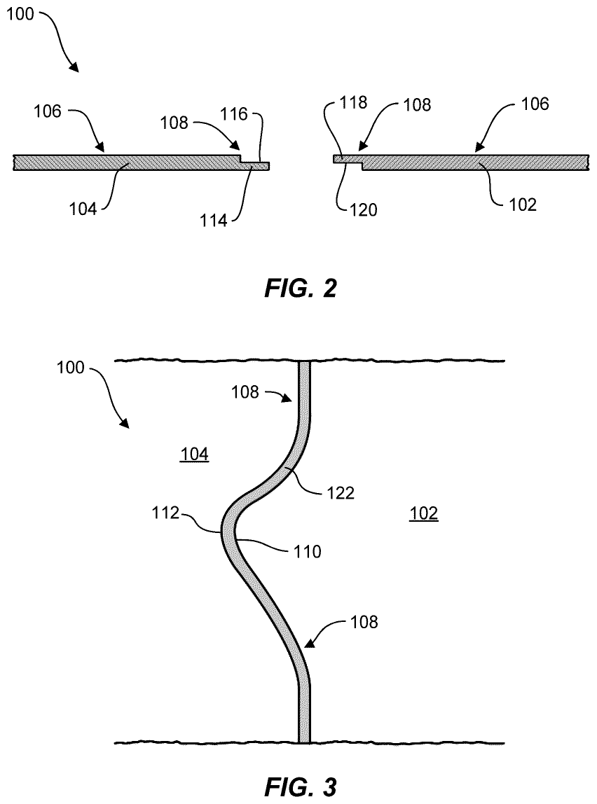

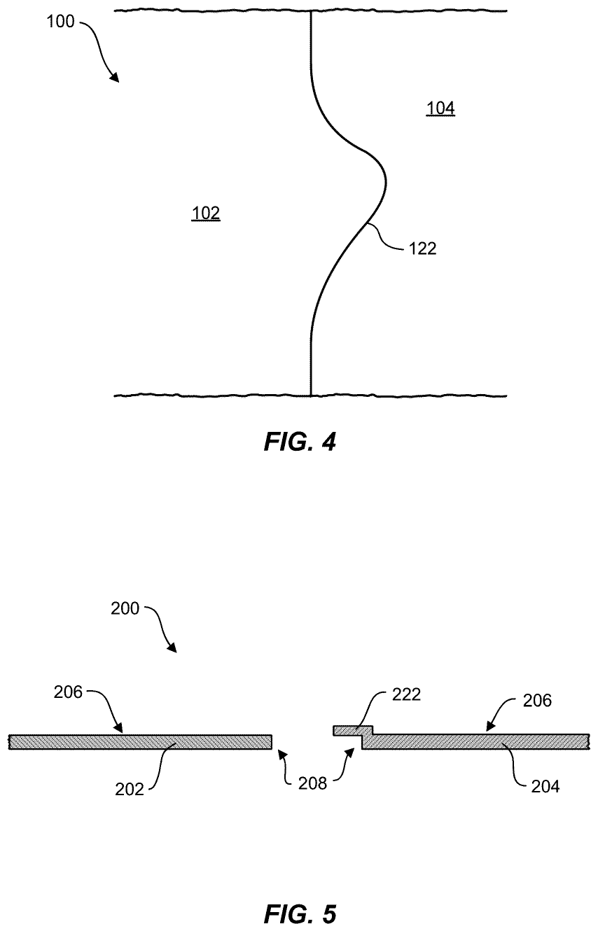

Referring now to FIG. 2, a section view of the duct segments 102 and 104 is shown. The body regions 106 of duct segments 102 and 104 may be substantially equal in thickness, such that when the two pieces are coupled together, the resulting air duct 100 has a substantially uniform thickness. In the edge region, duct segment 104 may include lip 114 which extends from the outermost edge of the edge region 108. This lip region may have a reduced thickness compared to the body region 106, and may be, as shown in FIG. 4, flush with the bottommost surface of the duct segment 104, such that the upper surface of this lip 114 forms a shelf 116 which sits below the uppermost surface of the body region 106.

The complimentary duct segment 102 may include lip 118 which is substantially similar to that of lip 114 in function. However, lip 118 may be formed flush with the uppermost surface of the duct segment 102, such that the lower surface 120 of the lip 118 sits above the lowermost surface of the body region 106. Complimentary lips 114 and 118 may allow duct segments 102 and 104 to fit together in an overlapping manner, forming a “lap joint,” wherein the shelf 116 and surface 120 are in contact with each other. This overlap may prove greatly beneficial in aligning the duct segments 102 and 104 prior to the coupling process by restricting the available degrees of freedom of motion, thereby reducing the need for additional tooling or equipment to hold the segments in place. The embodiment shown in FIG. 1 may for example, be held in place with simple C-clamps before joining segments 102 and 104 together.

With reference to the exact configuration of lips 114 and 118, those of skill in the art will understand that lip 114 may be instead found on segment 102, and lip 118 on segment 102, such that segment 104 is on top of segment 102 along the length of edge region 108.

In embodiments, air duct segments 102 and 104 may be formed using additive manufacturing techniques. For example, air duct segments 102 and 104 may be formed using a additive manufacturing modalities such as electron-beam, laser, or DED. Using additive manufacturing methods allows for a greater diversity and complexity of shapes of tabs 110 and recess 112, as well the formation of lips 114 and 118. Traditional sheet metal manufacturing methods may be unable to produce such features, or at least not without significant difficulty.

In some embodiments, such as those shown in FIGS. 1-10, the ducts are formed from a metallic material, although it is contemplated within the scope of the invention that other materials, such as polymers or composites, may be used as well. In some embodiments, the ducts may be manufactured from aluminum or an aluminum based alloy, titanium or a titanium-based alloy, Inconel, steel, steel alloys, or stainless steel such as precipitation-hardened (e.g., 17-4 PH) stainless steel, copper, copper-based alloys, or other material systems.

FIGS. 3 and 4 show the duct 100 after duct segments 102 and 104 are coupled together. Segments 102 and 104 may be coupled together using any process known to those in the art, including welding. FIG. 3 shows weld 122 which extends along the length of the edge region 108. The lap joint formed by the adjoining lips 114 and 118 allows for a cleaner weld compared to a typical butt joint weld, thereby reducing or eliminating the need for additional grinding or weld cleanup work along the length typically inside the duct. Furthermore, the lap joint along edge region 108 may also prevent the weld from seeping into the interior of the duct, resulting in a performance improvement due to a cleaner and smoother interior of the duct, as shown in FIG. 4.

In other embodiments not shown, the adjacent duct segments may be joined using high-strength adhesive, applied along the edge region 108, or joined using various mechanical fasteners known in the art.

In addition to improving the alignment of the adjacent duct segments 102 and 104, tab 110 and complimentary recess 112 may provide additional advantages during the welding process. For example, in a typical straight or linear weld bead (without the tab/recess combination), as the weld is being made, the heat created by this process builds along the length of the weld bead. Due to the relatively thin nature of the ducts, the increased heat may result in undesired distortion of the duct segments 102 and/or 104 along the weld. By introducing nonlinear features along the length of the edge region 108, the nonlinear arrangement may allow heat to dissipate more rapidly along the length of the weld compared to a straight weld. Specifically, by changing directions of the weld line, heat is moved away from the heat effected zone. The exact shape of the tab 110 and recess 112 may be adjusted based on application, and/or to achieve certain thermal or structural properties. For example, a hybrid pattern that includes straight portions interspersed between sinusoidal curves may reduce excess heat buildup without overly increasing the weld length and hence the cost. In certain embodiments, the non-straight weld line increases the overall weld length by about 10% or less. In addition to providing reduction of heat buildup, the non-straight weld line may assist with fitting matching segments. In some embodiments, the non-straight weld line is configured to provide a self-aligning and self-locking feature that mitigates shifting of the part in the transverse direction during assembly and may be used to fit the segments together with minimal and/or simple tooling.

FIG. 5 shows an alternative embodiment of a duct 200, which is substantially similar to duct 100 shown in FIGS. 1-4. For brevity and convenience, reference numbers 200-299 correlate to reference numbers 100-199 (body region 206 is equivalent to body region 106, edge region 208 is equivalent to edge region 108, etc.) unless otherwise noted. In some embodiments, such as in FIG. 5, only one of segments 202 and 204 may include lip 222 which extends over the adjacent segment, while the other segment may not include a lip 222. Compared to the embodiment shown in FIGS. 1-4, duct 200 may be less expensive to produce, as only one edge region 208 of the complimentary segments 202 and 204 includes a lip 222.

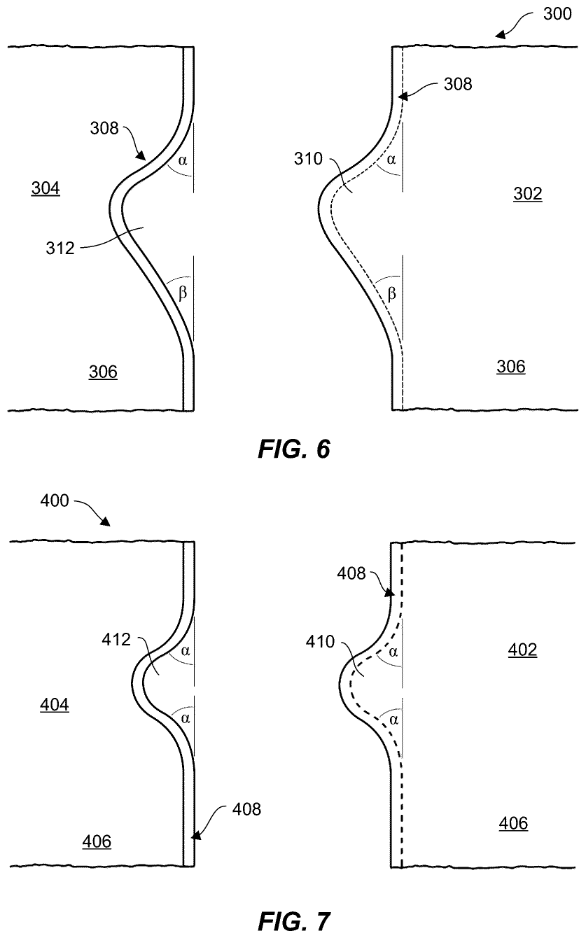

Ducts 300-700 shown in FIGS. 6 through 10 are substantially similar to ducts 100 and 200. For brevity and convenience, reference numbers 300-399, 400-499, 500-599, 600-699, and 700-799 each correlate to reference numbers 100-199 (body region 306 is equivalent to body region 106, edge region 508 is equivalent to edge region 108, tab 610 is equivalent to tab 110, etc.) unless otherwise noted.

FIG. 6 shows an embodiment of a duct 300 with a duct segment 302 having a tab 310 and a duct segment 304 having a recess 312. Both tab 310 and recess 312 form a continuous, tangential curve along a portion of the edge region 308. The tab 310 (and recess 312) is asymmetrical, having a more obtuse angular offset α at one end, while the angular offset at the other end, β, is more acute. The asymmetrical nature of tab 310 and recess 312 may be preferable in certain applications, such as in vertical applications where the air duct segment 302 is arranged vertically with respect to gravity, compared to embodiments where the tab and recess are symmetrical (such as in FIG. 7). The exact values of α and β may vary depending on the application, the capabilities of the additive manufacturing process or machine, or the materials used. Although α and β may each be any suitable angle between zero degrees and 90 degrees, it may be preferable, in some embodiments, for both α and β to be no greater than 60 degrees. Although in the illustrated embodiment α is greater than β, in other embodiments not shown this relationship may be the inverse.

FIG. 7 illustrates an alternative embodiment 400 of a duct which is substantially similar to that of duct 300. However, tab 410 and recess 412 form a symmetrical, continuous, tangential curve along a portion of the edge region 408. In some embodiments, the tab 410 and recess 412 may form a substantially sinusoidal, parabolic, or hyperbolic curve. In the illustrated embodiment, each end of the tab or recess is angularly offset at the same angle α. Again, the angle α maybe any suitable angle between zero and substantially 90 degrees. In some embodiments, the angle α maybe less than or equal to 60 degrees.

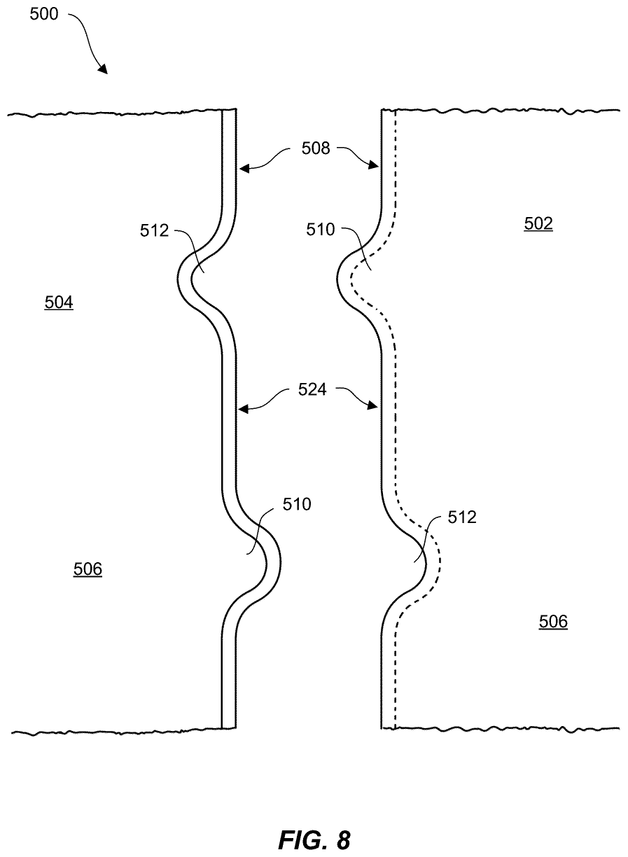

FIGS. 8 through 10 depict various alternative embodiments of complimentary tabs and recesses. Depending on the application and desired properties, the edge regions of the various duct segments may include more frequent tabs and/or recesses. For example, it may not be necessary to have continuous tabs, and as such there may be a combination of linear edge portions and tab sections. An example of this can be seen in FIG. 8, wherein the duct segments 502 and 504 have tabs 510 and recesses 512, as well as linear sections 524 located between the tabs and recesses. Likewise, each segment 502 and 504 may include one or more of a tab 510 and a recess 512.

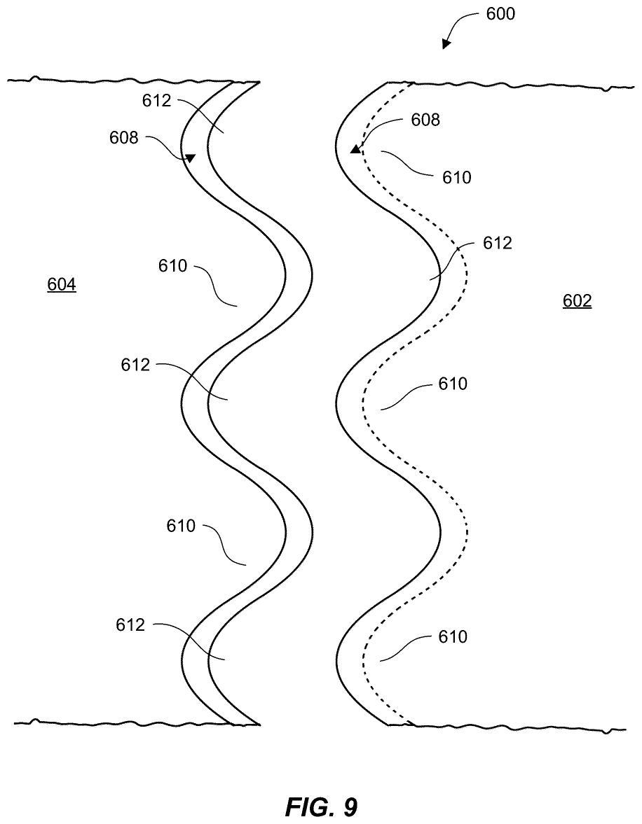

The embodiment shown in FIG. 9, unlike that of FIG. 8, does not include any linear sections along the edge region 608. Instead, the edge region 608 forms a continuous curve along its length, with alternating tabs 610 and recesses 612 on both segments 602 and 604. The edge region 608 may form a sinusoidal curve along its length, or any other desired curvature.

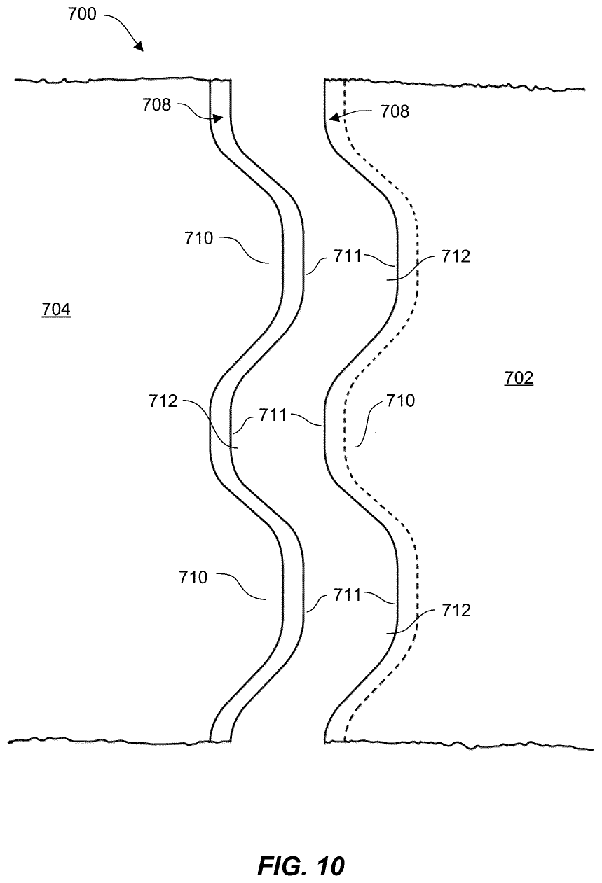

FIG. 10 illustrates another alternative embodiment, wherein the tabs 710 and recesses 712 do not form continuous, tangential curves, but instead include straight portions 711 within the tabs and/or recesses.

In each of the embodiments shown, the air ducts or duct segments are relatively planar along the edge region. In some embodiments, the edge region may be substantially planar, while in other embodiments the edge region may be formed into a simple shape. For example, it is contemplated within the scope of the invention that, in some embodiments, the edge region may be curved in nature.

Some embodiments may combine various features shown or described above without departing from the scope of the invention. For example, in some embodiments an air duct may be formed via duct segments having complimentary curved tabs and recesses which may also fit together to form a lap joint.

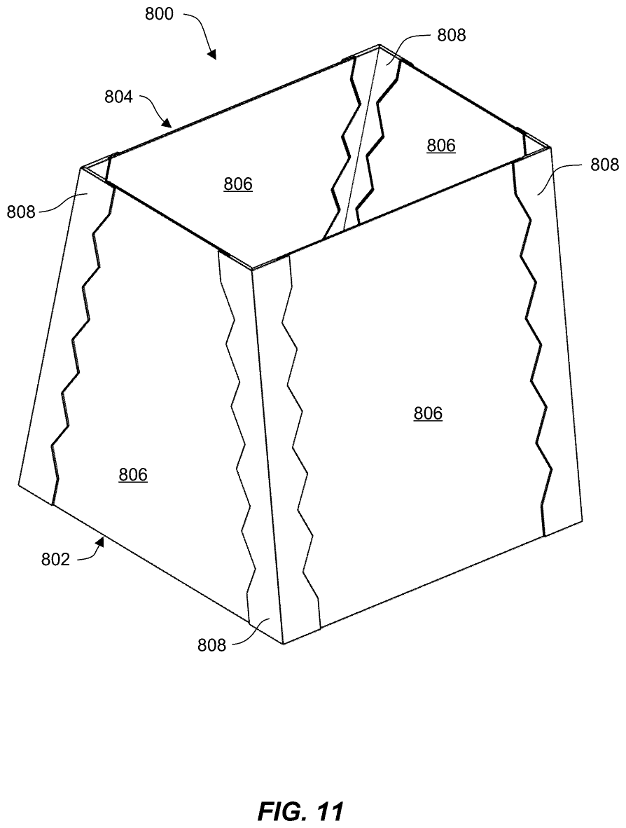

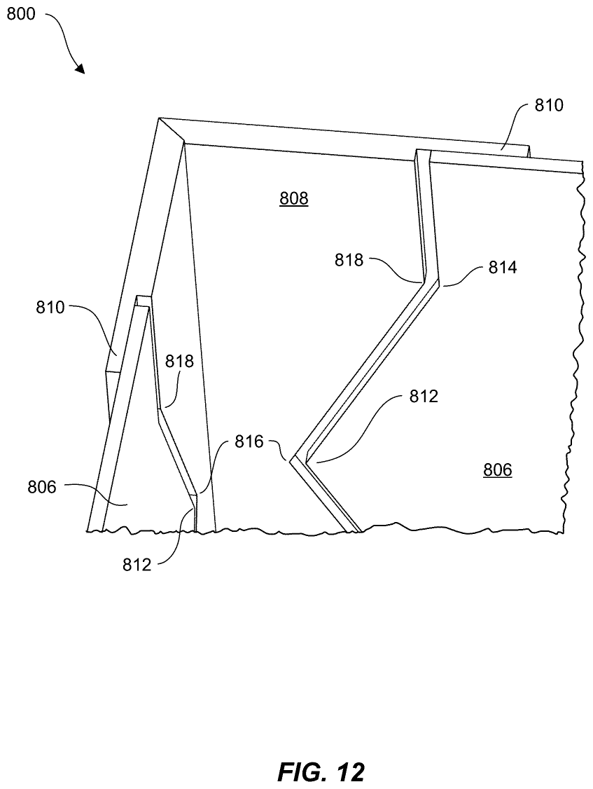

FIG. 11 and FIG. 12 illustrate another embodiment of a fluid duct 800 which performs substantially the same functions as fluid ducts 100-700 described above. However, unlike the embodiments described above, duct 800 may be formed from a combination of conventional sheet metal and materials shaped with additive manufacturing. This “hybrid” of conventional construction and additive manufacturing may offer additional advantages compared to ducts formed purely conventionally or formed purely using additive techniques. For example, relatively planar sections or sections having simple geometry (such as gradual curves) of the duct 800 may be formed using conventional sheet metal and conventional techniques (such as routing, laser cutting, or stamping, for example), while areas of complex geometry, such as sharper curves, corners, or various edge regions, may be formed using additive techniques. This allows for a similar level of geometric freedom to additive ducts 100-700, while using conventional sheet metal for simpler areas may reduce cost and/or production time compared to a duct formed solely using additive techniques.

As shown in FIG. 11, duct 800 includes an inlet 802 and an outlet 804, joined by the body of the duct 800 formed from main or primary body regions 806 and curved edge regions 808. The curved edge regions 808 may alternately be referred to as secondary body regions in some embodiments. In some embodiments, the inlet and outlet may be substantially similar in size and shape, while in other embodiments the size and/or shape of the inlet may differ from that of the outlet, forming a tapered duct as in the illustrated embodiment. The main body regions 806 are formed from conventional sheet metal, while the curved edge regions 808 are formed using additive manufacturing techniques. The main body regions 806 and the curved edge regions 808 may be coupled together via welding, adhesives, or may use mechanical fasteners. In embodiments where the main regions 806 and the curved edge regions 808 are welded together, the regions are welded at a butt joint, wherein the weld bead is disposed on an external surface of the duct 800, resulting in an interior surface of the duct 800 that is substantially smooth and continuous. In some embodiments, the curved edge regions 808 may include a lip 810 similar in shape and function to the lip 222 shown in FIG. 5, wherein a portion of the lip extends over an edge of the main body region 806. This results in a lap joint weld as opposed to a butt joint weld, which may be desirable.

The curved edge regions 808 may be formed unitary (i.e., from a single piece of material), or may be formed by joining two or more adjacent additively-manufactured elements via known methods such as welding, adhesives, or the like. Likewise, in some embodiments the curved edge region 808 may form a continuous or smooth curve, while in other embodiments the curved edge region 808 may include defined vertices or edges, such as in the illustrated embodiment.

As best shown in FIG. 12, the main body regions 806 and/or the curved edge regions 808 may include one or more self-locating or self-locking features, such as complimentary tabs and recesses similar to those shown in FIGS. 6-10. In the illustrated embodiment, the main body regions 806 and the curved edge regions 808 are formed such that the resulting joint between them forms a jagged alternating pattern. Generally, along the edge which abuts the curved edge regions 808 the main body regions 806 include a projection or tab 812 and/or a recess 814 which is configured to selectively mate with a corresponding recess 816 and/or projection 818 located on the curved edge region 808. In some embodiments, the self-locating features may form continuous tangential curves similar to those shown in FIGS. 6-10, while in other embodiments the self-locating features may appear more jagged (i.e., with defined vertices along the edge of the respective region) as in the embodiment shown in FIGS. 11 and 12. These self-aligning features may eliminate the need for complex assembly hardware such as various forming or welding tools, thereby reducing assembly cost and time.

Although the invention has been described with reference to the embodiments shown in the attached drawing figures, it is noted that the equivalents may be employed and substitutions made herein without departing from the scope of the invention as recited in the claims.

Having thus described various embodiments of the invention, what is claimed as new and desired to be protected by Letters Patent includes the following:

1. A duct for fluid transport, comprising:
a first duct segment and a second duct segment, each segment having a body region and an edge region, the second segment being configured to couple with the first segment along the edge region;
at least one projection extending from the edge region of the first segment; and
at least one recess disposed along the edge region of the second segment, the recess being substantially similar in shape to the projection;
wherein:
the first and second duct segments are formed using an additive manufacturing process; and
at least one of the first duct segment and the second duct segment includes a lip extending along a length of the edge region.

2. The duct according to claim 1, wherein the duct is formed from a material selected from a group consisting of: aluminum, aluminum alloy, titanium, titanium-based alloy, Inconel, steel, steel alloy, stainless steel, copper, or copper-based alloy.

3. The duct according to claim 1, wherein the at least one projection extending from the edge region of the first segment is a plurality of projections extending from the edge region of the first segment, and the at least one recess disposed along the edge region of the second segment is a plurality of recesses disposed along the edge region of the second segment.

4. The duct according to claim 1, wherein the at least one projection is a substantially symmetrical tab forming a continuous, tangential curve along a portion of the edge region of the first segment.

5. The duct according to claim 1, wherein the at least one projection is an asymmetrically formed tab forming a continuous, tangential curve along a portion of the edge region of the first segment.

6. The duct according to claim 1, further comprising at least one projection extending from the edge region of the second segment and at least one recess disposed along the edge region of the first segment, the recess being substantially similar in shape to the projection.

7. The duct according to claim 1, wherein each of the first duct segment and the second duct segment includes a lip extending along the length of the edge region.

8. A duct for fluid transport, the duct comprising:
a body having an inlet at a first end and an outlet at a second end and comprising at least one main body region and at least one secondary body region, each body region having an edge portion extending along a perimeter thereof;
wherein:
the at least one main body region is formed from sheet metal;
the at least one secondary body region is formed an additive manufacturing process;
the edge portion of the at least one main body region and the edge portion of the at least one secondary body region are rigidly coupled together.

9. The duct according to claim 8, wherein the at least one main body region and the at least one second body region are coupled together via welding.

10. The duct according to claim 8, wherein the at least one main body region and the at least one secondary body region are coupled together via mechanical fasteners.

11. The duct according to claim 8, wherein the at least one secondary body region further includes a lip extending at least partially along the edge portion thereof, such that the lip extends at least partially over the edge portion of the at least one main body region.

12. The duct according to claim 8, further comprising at least one projection extending from the edge portion of the at least one main body region and at least one recess disposed along the edge portion of the at least one secondary body region, the recess being substantially similar in shape to the projection.

13. The duct according to claim 8, wherein each secondary body region of the at least one secondary body region is formed from a single piece of material.

14. The duct according to claim 8, wherein each secondary body region of the at least one secondary body region is formed from at least two segments coupled together.

15. The duct according to claim 8, wherein each main body region of the at least one main body region is formed from a single piece of material.

16. The duct according to claim 14, wherein each main body region of the at least one main body region is formed from at least two segments coupled together.
